(19) United States
(12) Patent Application Publication
(10) Pub. No.: US 2008/0263875 A1
(43) Pub. Date: Oct. 30, 2008

(54) Cutting Tool

(76) Inventor: Roy Barry, County Meath (IE)

Correspondence Address: SUMMA, ALLAN & ADDITON, P.A., 11610 NORTH COMMUNITY HOUSE ROAD, SUITE 200, CHARLOTTE, NC, 28277, US

(21) Appl. No.: 12/090,740

(22) PCT Filed: Oct. 20, 2006
(86) PCT No.: PCT/IE2006/000115

§ 371 Date: Apr. 18, 2008

(30) Foreign Application Priority Data
Oct. 20, 2005 (IE) S20050702
Sep. 12, 2006 (IE) S20060671

(51) Int. Cl. B26F 1/32; B26B 3/00

(52) U.S. Cl. 30/360; 30/315

(57) ABSTRACT

A tool suitable for inscribing and removing a portion of a wooden member, comprising: a support member (2), first and second blades (10, 20) extending substantially perpendicularly from the support member (2) in spaced apart parallel relationship, a third blade (30) extending between opposite lateral ends of the first and second blades (10, 20), cutting edges (11, 21, 31) on the blades (10, 20, 30), which between them define the outline of the portion of wood to be inscribed and removed, and a first control means to control the depth of cut of the third blade (30) when the tool is used to cut away the inscribed portion.

### FIELD OF THE INVENTION

The present invention relates generally to hand tools and particularly to carpentry tools, such as die cutters and punch-out tools for use in preparing the edges of doors and door jambs for fittings, creating recesses for joinery, and particularly for preparing recesses for hinge fittings and the like.

### BACKGROUND TO THE INVENTION

There are currently a number of different methods commonly used to prepare recesses in doors and door jambs for the flush attachment of fixings such as hinges, locks and the like. The most basic of these methods involves initially scoring the outline of the area to be recessed with a knife or chisel bit (typically a rectangular shaped area), after which the wood of the area to be recessed is usually removed bit by bit with a chisel. The chiselling process is time consuming, often taking as long as ten to twenty minutes to chisel out a straight-edged recess of the correct uniform depth. In addition, the knife can sometimes follow the wood grain causing damage to the surrounding wood.

US2002112354 provides a means to overcome the dangers of stray and speed-up the manual process. US2002112354 provides a door mechanism punch-out apparatus for preparing recesses in doors and door jambs to accommodate flush installation of door hardware (latches, strikes, and hinges) into doors and door jambs. The door mechanism punch-out apparatus comprises a plate, a bar, and a blade. The bar is fixedly connected to the plate, perpendicularly extending from the plate in one direction. For preparing a strike or hinge recess in a door jamb, the blade of the apparatus exists along the perimeter of the plate, perpendicularly extending from the plate in a direction opposite that of the bar. In use, the plate is placed over the area to be recessed and the bar is punched or hammered briskly to indent the correct area of the wood. The scribed area must then be chiselled in the normal fashion. For some woods, the scribed area will detach from the wood when the punch is removed, but this carries with it the danger that the depth of the area removed will be uneven.

A more modern approach to the task is the use of a router and jig assembly, most of which require specific machinery and a source of mains electricity. The jig assembly serves as a template, which is placed over the wood. The router then removes the wood to the predetermined depth according to the template. While using routers and jigs can minimise the danger of damaging the surrounding wood, the procedure can be time consuming. The current trend in the field is for the further development of routers and jigs. While these may have applications to large scale operations, they can be expensive, bulky and time consuming. Furthermore, if the cut-outs are prepared in advance, these may not be in the correct plane when the door is installed on-site as the relevant dimensions of different door jambs in different locations and buildings may have altered or been altered since fitting.

For the above reasons, there still exists an unmet need to provide a simple and efficient tool that can quickly remove the precise amount of wood to create an even indentation for flush attaching of a door fitting, such as a hinge or lock.

### SUMMARY OF THE INVENTION

In one aspect, the present invention provides a tool suitable for inscribing and removing a portion of a wooden member (and/or suitable for inscribing and cutting out a hinge recess from a door frame) comprising:
a body (support member) (attachable to), first and second blades extendable substantially perpendicularly from the body in spaced apart parallel relationship, the length of the cutting edges of the first and second blades defining a maximum cut-width,
a third blade extendable between opposite lateral ends of the first and second blades, (the first, second and third blades) thereby forming a substantially U-shaped inscribing blade;
and further comprising a first control means positionable (located; and may be adjustable) such that the distance the third blade can penetrate through a piece of wood along the longitudinal axis of the third blade may be limited by the first control means, said distance defining a removing-cut length.

The first control means may be any means that acts to control or limit the depth the third blade can penetrate a portion of wood. The feature that permits or limits the third blade to travel through a piece of wood is the absence or presence of impediments (such as the first control means) set tangential to any one of the first, second or third blades in a direction away from the space outlined by the first, second and third blade. This may be located outwith the space defined by the three blades, for example, along the reverse, or back surface (the outer face) of the third blade, that is, the surface facing away from the first and second blades. So, for example, the first control means may be positioned tangential to the third blade and pointing away from the first and second blades. It will be appreciated that the full length of the first and second blades do not necessarily have to be used. In some embodiments, the effective cut-width may be preset (see especially the embodiments with a cut-width determining member, below). The effective cut-width may be defined as the portion of the maximum cut-width used to make the inscribing cut (in some embodiments this may be the maximum cut-width). The effective cut width is the longest length of the portion of the first and second blade that can rest upon a substantially flat surface (whose uninterrupted surface area is greater than the surface area outlined by the first, second and third blades)

In some embodiments, the effective cut-width is substantially equal to the removing-cut length. In these embodiments, the length of the inner face of the third blade does not need to be substantially equal to the cut-width, provided that the outer face of the third blade permits the third blade to penetrate the wood a cut-length distance substantially equal to the effective cut-width. In use, the portion of the wooden member that is removed need not lodge in the space defined by the first, second and third blades, but rather can be pushed upwards and away from the tool and the wooden member. In some of these embodiments, the inner face of the third blade is substantially equal in length to the cut-width, and the first control means is located in the space defined between the three blades.

Consequently, in some embodiments, the interior space defined by the first, second and third blades may be occupied to a large extent by a solid block (for example, to provide increased weight and/or strength, or to act as a second control means (see below)), provided that the first, second and third blades can still penetrate the wooden member a sufficient depth to make the inscribing cut. In some embodiments, the inscribing stop may be located in the space defined by the first, second and third blades, or may even constitute a solid block or extension of the support or body.

This general embodiment and further embodiments thereof may be termed the 3-blade version. In the 3-blade versions, the third blade acts as a removing blade to remove the portion of wood in the inscribed recess. The first control means may be a removing stop. The removing stop may be extendable tangentially to one or more of the first, second and third blades. The removing stop may be located inside the space defined by the first, second and third blades, or it may be located outside this space (for example, pointing away from the first and second blades). In some embodiments, the first control means extends away from the third blade in a in a direction away from the first and second blades. In some embodiments, the first control means extends perpendicular to the third blade.

In some embodiments, the present invention provides a tool suitable for inscribing and cutting out a hinge recess from a door frame, the tool comprising
a first and second blade attachable to a body,
the first and second blades disposed substantially parallel to each other and extending substantially perpendicularly away from the body in the same direction, the length of the cutting edges of the first and second blades defining a maximum cut-width,
at least one laterally opposite end of the first and second blades connectable by a third blade, the first, second and third blades thereby forming a substantially U-shaped inscribing blade;
the first and second blades each further comprising a second cutting edge, said second cutting edges defining a fourth and fifth blade respectively, with at least one laterally opposite end of the fourth and fifth blades connectable by a sixth blade, thereby forming a substantially U-shaped removing blade,
and further comprising at least one removing stop positionable such that the distance the sixth blade can penetrate through a piece of wood along the longitudinal axis of the sixth blade may be limited by the removing stop, said distance defining a removing-cut length.

This general embodiment and further embodiments thereof may be termed the 6-blade version. In further embodiments of the 6-blade version, the sixth blade may extend from the body. The sixth blade acts as a removing blade to remove the portion of wood in the inscribed recess.

In some embodiments of the 3-blade and 6-blade versions, the effective cut width is substantially equal to the removing-cut length.

The features discussed herein all are applicable to and refer to all embodiments where technically feasible, except where expressly indicated not to apply to particular embodiments.

In use, the user places the tool at the edge of a piece of wood, such as a door jamb, with the free ends of the first and second blades at the edge of the wood and perpendicular to the edge, thus, the substantially U-shaped inscribing blade will outline a substantially U-shape at the edge of the piece of wood. The user then presses or punches the tool into the wood (e.g., using a mallet) up to the required depth to create the necessary first incision outlining the portion of wood to be removed. Depending on the thickness of the blade, and the angle of the bevel of the blade, the inscribing blade may be naturally disposed to penetrate to the depth of the beveling with relative ease, and to require increased effort to drive the inscribing blade into the wood beyond that depth. In alternative embodiments, the inscribing blade may easily penetrate the wood beyond the depth of the bevel, in which case the user may either exercise judgment in deciding when to stop the inscribing process, or the user may additionally utilise an inscribing stop to control the depth of penetration of the inscribing blade (see below). Of course, the nature of the wood and of the material of the blades themselves will also dictate to an extent how easily and how deeply the inscribing blade penetrates the wood.

The tool is then removed and the removing blade (the third blade in the 3-blade versions and the sixth blade in the 6-blade versions) is placed against the wood such that the two ends of the removing blade are in contact with the deepest inscribed points made by the ends of the first and second blades respectively, at the edge of the wood (e.g., substantially perpendicular to the inscribing cut). The user then drives the removing blade through the wood up to the point permitted by the removing stop, thereby removing the portion of wood in the inscribed recess (typically as a single piece). The advantage of having the effective cut-width substantially equal to the removing-cut length (the maximum distance the third blade can penetrate the wood) is that the removing blade penetrates the wood substantially the correct distance required to ensure a clean cut. In some embodiments, the user of the 3-blade versions may then rotate the tool 90° after making the inscribing cut to place the third blade against the edge of the wood perpendicular to the position of the tool when making the inscribing cut. In preferable embodiments of the 6-blade version, the removing blade will be substantially perpendicular to the inscribing blade, requiring the user to rotate the tool 180° after making the inscribing cut to place the removing blade against the edge of the wood. A further advantage of the present invention is that the tool cleanly, precisely and reliably removes the portion of wood, even against the grain of the wood.

If the removing-cut length is shorter than the effective cut width, the removing blade may be too short to reach the full extent of the inscribed recess and a second cut of the removing blade will be required after removing a first portion of the recess material. If the removing blade is longer than the effective cut-width, there is a danger that the removing blade will penetrate the wood beyond the cuts made by the inscribing blade. However, in alternative embodiments of the invention, the removing-cut length may be substantially greater than the effective cut-width whilst in further alternative embodiments, the removing-cut length may be substantially less than the effective cut width. Such embodiments may be useful and/or desirable in conjunction with one or more features of the invention, such as the inscribing stop, interior blades(s), 6-blade versions, removing guide, drill bit attachment, housing, inscribing guide, removing guide, cut-width determining member and so on. In particular, embodiments where the effective cut width is substantially greater or lesser than the length of the removing blade may be suitable for use with the embodiments wherein the tool is mounted within a housing, either for spring biased activation, drill bit activation or electrical activation, as described below. Such embodiments may also be particularly suitable for use in combination with other features, such as an inscribing guide, and/or cut-width determining member.

Consequently, the invention also provides for a tool suitable for inscribing and removing a portion of a wooden member (and/or suitable for inscribing and cutting out a hinge recess from a door frame) comprising:
a body (support member) (attachable to), first and second blades extendable substantially perpendicularly from the body in spaced apart parallel relationship, the length of the cutting edges of the first and second blades defining a maximum cut-width,
a third blade extendable between opposite lateral ends of the first and second blades, (the first, second and third blades) thereby forming a substantially U-shaped inscribing blade; characterized by further comprising one or more of the following: an inscribing stop, interior blades(s), at least 6-blades, a removing guide, drill bit attachment, housing, inscribing guide, removing guide, cut-width determining member, integral drill, hand-held power unit, member for automatic operation, one or more removable blades, removable removing guides permitting different depths to be catered for, and various described combinations of dimensions of blades that are suitable for particular uses directed towards particular standard hinge sizes. It will be appreciated that all of these features, individually and/or in various combinations (and as expanded and discussed throughout the specification and claims), as well as all of the various other features described herein may be selected alone or in combination to characterize the invention. Moreover, it will be appreciated that each of the various aspects of the invention may be combined with any of the features herein described to arrive at particular versions of the tools of the invention suitable for particular purposes.

The longitudinal axis of a blade extends through the cutting edge of that blade to the body. The blades are formed with straight cutting edges. Preferably, each blade is substantially planar. The blades may be attachable to the body and disposed substantially parallel to each other. Each blade may extend substantially perpendicular away from the body in the same direction. The body may further comprise one or more end-walls and side-walls upon which the blades are attachable. The one or more end-walls and side-walls may be integrally formed with either the blades and/or the body, or they may be independently formed from one or more of the blades and the body. One or more of the blades may therefore be integrally formed with the body. One or more blades may be independently formed from the body. The cutting edges of the first and second blades may be of substantially equal length. Where the cutting edges of the first and second blades are not of substantially equal length, the maximum cut-width A is the minimum length of the cutting edge of the first or second blade.

The removing stop may be attachable to the tool. The removing stop may be extendable tangential to the longitudinal axis (plane) of the removing blade, such that movement of the removing blade through a piece of wood in the direction of the removing blade's cutting edge is limited by the removing stop. The removing stop controls the length of cut of the removing blade during removal of the portion of wood from the recess to create the substantially rectangular recess. In some embodiments, the at least one removing stop extends from the body tangential (in some embodiments, perpendicular) to one or more of the blades. In some embodiments of the invention, (for example embodiments of the 3-blade version), the body of the tool acts as the removing stop (or is integrally formed with it). In some of these embodiments, the body of the tool may extend beyond the plane of the third blade to provide the removing stop. In alternative embodiments, especially embodiments of the 6-blade versions, the third blade, or a side wall to which the third blade is attached or portions thereof acts as the removing stop. In further embodiments, the removing stop is located on the third blade. In further embodiments, a removing stop is located on at least one or more of the first and second blades (and/or the end-walls to which they may be attached).

The third blade may be substantially planar. In other embodiments the third blade is connectable to the body and extends perpendicularly from the body. In some embodiments, the blades (any one or more of the first, second, third, fourth, fifth, sixth o seventh blades, or the interior blades) may be substantially wedge shaped or may substantially comprise a portion that is substantially wedge shaped.

In further embodiments of the 3-blade version, the second laterally opposite ends of the first and second blades are connected by a seventh blade, thereby forming a quadrilateral-shaped blade. This quadrilateral blade can be likened to two overlapping U-shaped blades; the inscribing blade being defined by the first, second and third blades, and the removing blade being defined by either the third or seventh blades. The seventh blade can be used as a guide to align the tool with the edge of the wood when inscribing the wood. In addition, this arrangement provides an advantage in that the seventh blade can aid in the inscribing process, especially in the cases of particularly hard wood or where the wood presents an uneven edge. The body may further comprise a second side-wall extending between and substantially perpendicular to the two end-walls, the seventh blade may be attachable to the second side-wall. The second side-wall may be substantially planar. In some embodiments the seventh blade is connectable to the body and extends perpendicularly from the body. In such an arrangement, the tool takes the form of an open-ended box.

The body may be quadrilateral in shape. In some embodiments, the body is in the form of a plate. In some embodiments, the body is of the form of a substantially solid quadrilateral block, ideally with such apertures or attachment points as necessary to provide the additional features of the invention. In embodiments of the invention adapted as manual hand tools, the body may preferably further comprise a handle and/or strike bar attached thereto. The handle and strike bar may be integrally formed. In some embodiments, the handle and/or strike bar is removable. In embodiments of the 6-blade version it may be preferable to have a removable handle and/or strike bar that can detach from the body and be attached to the side-wall. In further embodiments, it may be desirable to have the handle and/or strike bar located on the third blade or the side-wall. In some embodiments of the invention, the tool may be directly attachable or connected to a drill bit or rivet gun bit. In such embodiments, the vibration and/or the hammer action of the drill or rivet gun punches the tool into the wood.

In some embodiments of the invention, the tool further comprises at least one interior blade extending perpendicular from the base in the same direction as the first and second blades, and preferably by substantially the same distance. At least one interior blade may be parallel to the first and second blades. The at least one interior blade may be substantially planar. In some embodiments of the 6-blade version, each interior blade may be parallel to the first and second blades and may comprise an additional cutting edge aligned with and parallel to the cutting edges of the fourth and fifth blades. In some embodiments, the at least one interior blade is integrally formed with the body. In alternative embodiments, the at least one interior blade is independently formed from the body and is detachable. The body may further comprise interior walls; which may be integrally or independently formed with the body and/or integrally or independently formed from the interior blades. The presence of interior blades can assist in the inscribing process and also in the removing process by providing additional blades. In addition, the presence of interior blades may reduce the risk of damaging the wood beyond the recess area when removing the recess material, for example by splitting along the wood grain.

Further embodiments of the tool may further comprise at least one inscribing stop positionable such that the distance the inscribing blade can penetrate through a piece of wood (along the longitudinal axis of the inscribing blade) may be limited by the inscribing stop, said distance defining the cut-depth. The inscribing stop may be attachable to the tool and/or may extend tangential to the longitudinal axis (plane) of the inscribing blade, thereby preventing the movement of the inscribing blade through a piece of wood in the direction of the inscribing blade's cutting edge beyond the inscribing stop. The cut-depth may also be described as the maximum distance the inscribing blade may penetrate the wood prior to being stopped by the inscribing stop. The longitudinal axis (plane) of the inscribing blade extends through the cutting edge of the inscribing blade to the body. In some embodiments, the at least one inscribing stop extends from the body perpendicular to one or more of the first, second and third blades. An inscribing stop may be locatable on at least one, and preferably both, of the first and second blades. The inscribing stop may be locatable on one or more of the end-walls or side-walls.

In some embodiments, one or both of the removing stop and inscribing stop if present is integrally formed with the tool. The inscribing stop may be located inside the space defined by the first, second and third blades, and may be movable from this location, or may be integrally formed (for example, with one or more of the blades, side walls, end walls or and/or body). In alternative embodiments, one or both of the removing stop and inscribing stop if present are independently formed from the tool. The position of one or both of the removing stop and inscribing stop may be adjustable. This may be achieved by numerous means, such as providing one or more of the blades, body, end-walls or side-wall with a number of suitably arranged screw holes, grooves and/or slots, for example, and providing corresponding means of removable attachment on the inscribing stop and/or removing stop, such as screws, or pins or other means of attachment.

In a further embodiment of the invention, the removing stop and inscribing stop are integrally formed with each other. The positions of the integrally formed inscribing stop and removing stop may be adjustable from a first position to act as an inscribing stop and a second position to act as a removing stop. The combined inscribing and removing stop may be pivotably and/or slidably adjustable between at least these two positions and mounted on the blades, body, end-wall or side-wall of the tool. In further embodiments of the invention, the lengths of one or more of the blades is adjustable. In some embodiments, the lengths may be adjustable by adding on three-sided modules comprising an extension to the third blade and/or side-wall and body and an additional end-wall/first blade, thereby turning one of the previous first or second blades into an interior blade.

In some embodiments of the invention, one or both of the removing stop and inscribing stop if present extend between the first and second blades. At least one surface of the inscribing stop may be set substantially parallel to the blades of the inscribing blade. In some embodiments, particularly the 6-blade versions, the inscribing stop may extend the full width of the first, second or third blade. In further embodiments of the invention, particularly the 3-blade versions, the inscribing stop is locatable on the first and/or second blade, and does not extend across the full width of the first or second blade. In such embodiments, the distance between the third blade and the inscribing stop is substantially equal to or greater than the cut depth. This arrangement allows the removing blade to penetrate the wood to the full extent when the inscribing stop is in place. In some embodiments, the distance between the third blade and the inscribing stop is substantially equal to the cut depth.

Naturally, where distances are referred to or described, or are described as being substantially equal, it is intended that these distances take into account the additional thickness required to permit the various blades to penetrate the wood, and also to allow for minor imperfections and the natural unevenness of some wood surfaces

Although the invention and aspects thereof may be fashioned out of any suitable, durable, rigid material, hard metals or metal alloys are preferred. In particular, the invention may preferably be fashioned out of a metal alloy such as brass and/or hardened and/or tempered steel. In some embodiments of the invention, the tool may be fashioned out of Aluminium. The tool may also be fashioned out of zinc or steel. A further option is glass filled plastics. In some embodiments, at least the inner portion of the handle is fashioned from steel. In some embodiments, the removing and or inscribing guides may be fashioned out of zinc, or glass or steel filled plastics. The blades may be made of one or more of D2 tool steel, high speed steel, tungsten tipped blades or other specially coated blades.

In some embodiments of the invention, the blades are provided by beveled edges. The edges may be single beveled, with the single beveled edge of the blades pointing towards the body, rather than away from the body. In this way, the edges of the recess after the material is removed are straight, rather than beveled.

In some embodiments of the invention, one or more of the blades are integrally formed with the body. Such embodiments may be manufactured with the intention of being disposed of after the blades become blunted, although it may be possible to sharpen the blades a limited number of times without substantially impairing function. As repeated sharpening will reduce the length of the blades, embodiments with integrally formed blades may have only a limited lifespan.

In some embodiments of the invention one or more of the blades and/or side-walls and/or end-walls are independently formed from the respective wall or body to which they are attachable. In some embodiments each blade is independently formed and further provided with a blade support for engaging with one or more of the end-walls, side-walls and/or body. The blade support may further comprise one or more of an inscribing stop and removing stop. Preferably, the blade support is provided with a means of attachment to one or more of the body, side-wall or end-wall. In one embodiment, the blade support can slide into hollow side-walls and/or end-walls and the blades protrude from the side-or-end-wall. The straight edge of the side-wall may comprise an inscribing stop (see below); in such embodiments, it is preferred that the side wall does not extend across the full width of the blade, so as to allow the portion of the inscribing blade not housed within the full extent of the side wall to pass through the inscribed cut of the recess. In alternative embodiments, the blade support attaches to one surface of one or more of the side-wall, end-wall and body. Two or more of the blades may be integrally formed. One or more of the blades may be independently formed.

Further embodiments of the invention may additionally comprise a removing guide with a guide portion extendable away from the body and past the cutting edge of the removing blade, the guide portion being substantially parallel to the longitudinal axis of the removing blade and further being offset from the longitudinal axis of the removing blade by a distance of at least the cut-depth. The guide portion can be rested against the surface of the wood and thereby act as a guide to enable the user align the removing blade at the correct depth required to accurately remove the recessed material. A removing guide may be positionable along one or both of the first and second blades. In addition, the removing guide helps the user ensure that the removing blade is perpendicular to the ends of the inscribed cuts and not skewed, particularly if two removing guides are used, each one disposed on either side of the tool, for example, along, or on, the first and second blades.

In further embodiments of the invention, the inscribing stop may comprise a guide portion of a removing guide extending parallel to the first and second blades past the perimeter of the third blade, in the direction away from the third blade. In some 6-blade versions the guide portion extends beyond the removing blade.

In some embodiments the removing guide is integrally formed or attached to the inscribing stop and/or the removing stop. The position of the inscribing stop relative to the inscribing blade may be adjustable (for example by at least 90° or at least 180°) to permit the guide portion of the removing guide be moved to extend beyond the removing blade and so act as a removing guide. The position of the inscribing stop may be adjustable so as to enable the inscribing stop act as a removing guide. In some embodiments, the inscribing stop may be slidably adjustable; in further embodiments, the inscribing stop may be pivotably adjustable. In some embodiments, the removing guide is movably mounted on the support member such that the removing guide may be substantially movable along an axis substantially parallel to the lengths of the blades yet fixed in relation to movement along an axis substantially perpendicular to the lengths of the blades. The removing guide may be slidably mounted in a slot on the support member, running parallel to the axis of the blades.

In some embodiments of the invention, guide holes for fretwork, drilling, lock placement or screw holes may be provided in one or more of the group consisting of blades, side-wall, end-walls and body. Such guidelines may be provided on the third blade and/or side-wall. The tool may also be provided with one or more spirit levels. Optionally, the spirit level may be integrally formed with one or more of the group consisting of removing stop, inscribing stop, body, side-wall, second side-wall, end-wall and handle. The tool may be provided with at least one guide arm to permit the user to position the tool the correct distance from the end of the piece of wood prior to inscribing the wood. The guide arm may be extendable from the tool. In further embodiments, the position of the guide arm may be moved to permit the guide arm to act as a removing guide.

The guide arm may take the form of an inscribing guide. The invention may also comprise one or more inscribing guides, extending (from the body (support member)) past the cutting edges of the first, second and third blades such that when the first, second and third blades are resting on a substantially flat surface, with the ends of the first and second blades at the edge of the surface, the inscribing guide rests against the edge of the surface substantially perpendicular to the surface so as to align the ends of first and second blades with the edge of the surface. Thus, the inscribing guides may extend beyond the cutting plane, that is, beyond the plane defined by the first, second and third blades and in a direction away from the body. The inscribing guide may be substantially perpendicular to the third blade.

The present invention therefore may comprise a tool suitable for inscribing and removing a portion of a wooden member, comprising: a support member, first and second blades extending substantially perpendicularly from the support member in spaced apart parallel relationship, a third blade extending between opposite lateral ends of the first and second blades, cutting edges on the blades, which between them define the outline of the portion of wood to be inscribed and removed, a first control means to control the depth of cut of the third blade when the tool is used to cut away the inscribed portion, and further comprising one or more inscribing guides, extending past the cutting edges of the first, second and third blades, such that when the first, second and third blades are resting on a substantially flat surface, with the ends of the first and second blades at the edge of the surface, the inscribing guide rests against an edge of the surface substantially perpendicular to the surface so as to align the ends of first and second blades with the edge of the surface.

The inscribing guide may be located substantially parallel to the third blade and set apart from the third blade by the first and second blades. The inscribing guide may be located so as to permit the first, second and third blades be aligned on a surface at a substantially straight edge of the surface, wherein the first and second blades are aligned substantially perpendicular to the edge of the surface and the third blade is aligned substantially parallel to the edge and set apart therefrom. The inscribing guides allows the user to reliably align the tool on the edge of the door frame and so ensure that the inscribed area is both the correct size and also correctly aligned with respect to the edge of the door frame.

The inscribing guide may be integrally formed with the body (support), or it may be detachably removable from the body (support). The inscribing guide may be adjustable so as to permit the effective cut-width to be adjusted. For example, the inscribing guide may comprise an extendable cut-width determining member (such as a screw) that is extendable from the inscribing guide so as to adjustably limit the effective cut-width.

This can function by preventing at least a portion of the first and second blades from coming into contact with the wooden member and so being in position for inscribing the portion of wood to be removed. In some embodiments, the cut-width determining member is projectable through the inscribing guide, such that when at least a portion of the first and second blades are resting against a flat surface and the inscribing guide extends over an edge of the flat surface, and the cut-width determining member (e.g. the screw) adjustably projects past the inscribing guide and towards the general direction of the first and second blades, the cut-width determining member presses against the edge of surface and so adjustably controls the length of the portion of the first and second blades that lies along the surface.

The position of the inscribing guides on the tool may be adjustable such that the inscribing guide also acts as a cut-width determining member. Naturally, the feature of adjustable inscribing guides and/or combined inscribing guides and cut-width determining members may be used in any of the embodiments herein described, and may also be used in conjunction with separate cut-width determining members.

In some embodiments, the first control means or removing stop may be adjustable. For example, the first control means may be located at the rear face of the third blade and may be adjustable. This could be, for example, by means of a movable wedge-shaped section, set into a complimentary wedge-shaped socket within the body. Lateral movement of the wedge-shaped section across the complimentary incline of the wedge-shaped socket results in the wedge-shaped section emerging from the socket and thereby shortening the removing-cut length. Some embodiments may combine an adjustable first control means with a cut-width determining member. The first control means may also be slidably adjustable by means of guide slots in the body that can accommodate the fixing means for the first control means at a variety of distances from the edges of the blades.

Gradations may be provided on one or more straight edge surfaces of the tool selected from the group consisting of blades, inscribing blade, removing blade, body, side-wall, end-wall, second side-wall, removing stop, inscribing stop, removing-inscribing blade, guide portion, removing guide and guide arm.

The invention also provides blades for use with the tools of the invention in all the possible embodiments.

In a further embodiment, the invention provides for a tool suitable for inscribing and removing a portion of a wooden member, comprising:
a body, with first and second blades extendable substantially perpendicularly from the support member in spaced apart parallel relationship,
a third blade extendable between opposite lateral ends of the first and second blades,
cutting edges on the blades, which between them define the outline of the portion of wood to be inscribed and removed (U-shaped inscribing blade),
a first control means to control the depth of cut of the third blade when the tool is used to cut away the inscribed portion (removing-cut length),
and further comprising a removing guide with a guide portion extendable away from the support member and past the cutting edge of the third blade, the guide portion being substantially parallel to the longitudinal axis of the third blade and further being offset from the longitudinal axis of the third blade. Naturally, the features of this embodiment may be advantageously combined with any of the other features herein described.

In a still further embodiment of the invention, there is provided a tool suitable for inscribing and removing a portion of a wooden member, comprising:
a body, with first and second blades extendable substantially perpendicularly from the support member in spaced apart parallel relationship,
a third blade extendable between opposite lateral ends of the first and second blades, cutting edges on the blades, which between them define the outline of the portion of wood to be inscribed and removed (U-shaped inscribing blade),
a first control means to control the depth of cut of the third blade when the tool is used to cut away the inscribed portion (removing-cut length), and further comprising a second control means to control the depth of cuts of the blades when the tool is used to inscribe the portion to be cut (cut-depth). Naturally, the features of this embodiment may be advantageously combined with any of the other features herein described.

The present invention also provides for a tool suitable for inscribing and cutting out a hinge recess from a door frame, the tool comprising
a first and second blade attachable to a body,
the first and second blades disposed substantially parallel to each other and extending substantially perpendicular away from the body in the same direction, the length of the cutting edges of the first and second blades defining a maximum cut-width,
at least one laterally opposite end of the first and second blades connectable by a third blade, thereby forming a substantially U-shaped inscribing blade; the third blade defining a removing blade,
wherein the tool is moveably mounted within an external housing such that the inscribing blade and removing blade can each extend from the housing.

The tool may further comprise at least one removing stop positionable such that the distance the third blade can penetrate through a piece of wood along the longitudinal axis of the third blade may be limited by the removing stop, said distance defining a removing-cut length. Furthermore, the tool may also comprise at least one inscribing stop to limit the distance by which the inscribing blade can extend from the housing. The effective cut width may be substantially equal to the removing-cut length.

The maximum distance that one or both of the removing blade and inscribing blade can extend from the housing may be adjustable by means of adjusting the position of the inscribing stop or removing stop.

In a further embodiment of the invention, the tool may be spring mounted within an external housing. The external housing may be adapted to sit flush against a flat surface such that the inscribing blade and removing blade may be positionable so as to not extend beyond the housing. In some embodiments, one or more of the tool, the housing and the worm gear is further provided with means to control and/or limit the depth the blades are extendable away from the housing, comprising a first extension means to permit the inscribing blade extend by a first distance, termed the cutting distance and a second extension means to permit the removing blade to extend by a second distance, substantially equal to the effective cut width. In some embodiments of the invention, one or both of the extension means are adjustable and may be pre-set by the user. In some embodiments of the invention one or both of the extension means is located on the tool and or the housing.

In further embodiments of the invention, the tool is mounted within an external housing and is activated by a drill bit. The tool may be spring mounted within the housing. In some embodiments, the body of the tool is attached to one or more compression shafts extending through the housing and attachable to drill bit engagement means.

The compression shafts may be spring mounted. In some embodiments, the drill bit engagement means is one or more cogs. In some embodiments, the drill bit is formed as a worm gear adapted to engage with one or more cogs located on the compression shafts.

In some embodiments, one or more of the tool and the housing is further provided with means to control and or limit the depth the blades extend away from the housing, comprising a first extension means to permit the inscribing blade extend by a first distance, termed the cutting distance and a second extension means to permit the removing blade to extend by a second distance, substantially equal to the effective cut width. In some embodiments of the invention, one or both of the extension means are adjustable and may be pre-set by the user. In some embodiments of the invention one or both of the extension means is located on the tool and or the housing.

There may additionally be provided a torque control means (a torque control). Preferably, the torque control in attachable or attached to one or more of the drill, drill bit, housing or tool. The torque control is adapted to ensure the torque of the drill disengages when the inscribing blade is extended by the cut depth and/or the removing blade is extended by the effective cut width.

In some embodiments, one or both of the extension means are provided on a worm gear. This may be provided, for example, by a disengagement means on the worm gear, such as protrusions and/or cessation of the pitch of the worm bit such that the worm bit can only engage the cog of the compression shaft for a defined or pre-determined distance that correlates to an extension of the inscribing blade by the cutting depth. Similarly, a second disengagement means may be provided after the first disengagement means to enable the worm gear to disengage after the removing blade has extended by the cut width. One advantage of locating the disengagement means on the worm gear drill bit is that a selection of different drill bits may be provided, each with a different combination of inscribing and removing depths.

In further embodiments of the invention, the tool is mounted within an external body and is electrically operated.

The present invention also provides for a tool suitable for inscribing and cutting out a hinge recess from a door frame, the tool comprising
a first and second blade attachable to a body,
the first and second blades disposed substantially parallel to each other and extending substantially perpendicular away from the body in the same direction, the length of the cutting edges of the first and second blades defining a maximum cut-width,
at least one laterally opposite end of the first and second blades connectable by a third blade, thereby forming a substantially U-shaped inscribing blade; the third blade defining a removing blade,
wherein the tool further comprises a hand-held power unit, attachable to the body by means of a driver, the driver being movably engagable with the hand-held power unit such that the tool may be reciprocally extendable from the hand-held power unit.

The tool may comprise a power unit capable of delivering the force required to drive the blades into the wood. The tool may be extendable from the hand-held power unit in a reciprocal action: in some embodiments, both the extension and retraction of the driver and tool relative to the hand-held unit may be powered by the power source; in other embodiments, only one of the extension or retraction may be powered by the power source (e.g., such as where the power source is spring loading or compressed air, for example). The power source may electrical power: for example, battery power, or mains power. The hand-held unit may comprise a rechargeable battery. Other power sources are possible, for example compressed air, spring loading, or a liquid hydrocarbon fuel such as petrol. The tool may be connectable to the hand-held power unit by means of a driver. The driver may be fixedly attached to the body of the tool. The driver may be movably extendable from the power unit. In use, activation of the power unit causes the driver move in and out of the power unit with force and/or at high speed. This provides a jackhammer-like action to the tool that can be used to make the necessary cuts in the wood. In some embodiments of the invention, the tool may be separatable from the power unit; in some of these embodiments the tool may then be fittable with a removable handle, so as to permit the tool to be used manually and without a power unit. In some embodiments, the arms may be used as inscribing stops; wherein the arms are slidably movable past the cutting edges of the blades and towards the body by a maximum distance of the cutting depth C.

The removing cut length and/or cut length and/or cut width may be either fixed or fixable to suit standards of hinge dimensions, be they imperial or metric measurements. For example, the removing cut length may be between about ½″ (about approximately 12.7 mm) and about 4″ (about approximately 101.6 mm). Preferable lengths of the removing cut length are selected from the group consisting of about ½″, about 1″, about 1½″, about 2″, about 2½″, about 3″, about 3½″, about 4″. Preferably, the cut width is equal to the length of the removing blade. Preferably, the inscribing stop is located between about ⅛″ (about approximately 3.175 mm) to about 1″ (about approximately 25.4 mm) from the inscribing blade. Ideally, the cut-width is selected from the group consisting of about ⅛″, about ¼″, about ⅜″, about ½″, about ⅝″, about ¾″, about ⅞″, and about 1″. The above measurements may be expressed in metric form. Alternatively, the measurements may be metric standard units, for example inscribing stop may be located or locatable a defined distance that may be simply expressed in metric terms (e.g., about 1 mm, about 2 mm, about 3 mm, about 4 mm, about 5 mm and so on) and the removing-cut length may be selected from about 10 mm to about 200 mm; for example, about 21 mm or about 32 mm and so on. In some embodiments of the invention, the third blade may be about 100 mm×about 21 mm×about 3 mm, measured along its cutting edge length, length from cutting along blade length (i.e., the maximum cut depth) and width of the blade, measured at its widest point, rather than along the bevel. The third blade may also be about 75 mm×about 21 mm×about 3 mm. The first and second blades may be about 32 mm×about 21 mm×about 3 mm.

In some embodiments, the inscribing stop is set to permit an inscribing cut of about 2.75 mm in depth. In some embodiments, such as that of FIGS. 16-21, the cut depth may also be increased to about 3.75 mm. Some embodiments are adapted for an about 4″ long hinge (about 101.6 mm), for fitting into a depth of about 1¼″ (or about 32 mm). Some embodiments are adapted for hinges of about 3″ (about 76.2 mm) long, for fitting into a depth of about ⅞″ or about 21 mm.

One or more of the first control means, second control means, removing stop, inscribing stop or inscribing guide may be fitted or coated with a protection means. The protection means may suitably be a substance that can protect the wooden member or door from any unintentional damage arising from use of the tool Suitable materials include rubber, felt or plastic. In essence, any portion of the tool or any of its embodiments that are likely to come into contact with the door (apart from the blades), particularly those that act to control or limit movement, is suitable for fitting with a protection means. The first control means in particular may be fitted with, or comprise a protection means or be composed of or coated with a protective substance.

In some aspects, the present invention provides a tool that can inscribe the outline of a recess along the edge of a piece of wood, make the necessary incision cuts in the piece of wood and thereby define the shape of the recess to be created, and additionally remove the mass portion (wood within the recess) with a single additional movement. In some aspects, the invention provides a tool that ensures a uniform shaped portion of wood is removed.

### BRIEF DESCRIPTION OF THE DRAWINGS

FIG. 1 shows a perspective view of one embodiment of the invention.

FIGS. 2a and 2b depict the device in use.

FIG. 3 shows a further embodiment of the invention.

FIG. 4a-4d shows embodiments of the invention with removable blades.

FIG. 5 shows an embodiment of the invention with an inscribing stop extending between both end-walls.

FIG. 6A-6I show alternative embodiments of end-walls, side-walls, inscribing stops, removing stops and blades of the invention.

FIG. 7 shows an embodiment of the invention with a second side-wall.

FIG. 8 shows an embodiment of present invention with separate inscribing blade and removing blade.

FIG. 9 shows further embodiment of present invention with separate inscribing blade and removing blade.

FIG. 10 shows a further embodiment of the invention with a plurality of internal walls.

FIG. 11 shows an embodiment of the invention with a removing guide.

FIG. 12 shows an embodiment of the invention with additional features.

FIG. 13a shows an alternative embodiment of the invention with housing.

FIG. 13b shows a detail of the embodiment of FIG. 12a.

FIG. 14a shows an alternative embodiment of the invention with tool located within a housing with inscribing blade extended.

FIG. 14b shows an alternative embodiment of the invention with tool located within a housing with removing blade extended.

FIG. 15 shows an embodiment of the invention activated by a drill.

FIG. 16 shows an alternative embodiment of a tool of the invention.

FIG. 17 shows a further embodiment of a tool of the invention.

FIG. 18 shows the embodiment of FIG. 17 from a reverse angle.

FIG. 19 shows a further embodiment of a tool of the invention.

FIG. 20 shows the embodiment of FIG. 19 from a reverse angle.

FIG. 21 shows an embodiment of the invention with hand-held power unit.

FIG. 22 shows another view of the embodiment of FIG. 21.

FIG. 23 shows a plan view of the embodiment of FIGS. 21-22.

FIG. 24 shows a front-end view of the embodiment of FIGS. 21-23.

FIG. 25 shows a side-on view of the embodiment of FIGS. 21-24.

FIG. 26 shows the embodiment of FIGS. 21-25 making the inscribing cut.

FIG. 27 shows a side on view of the embodiment of FIG. 28 showing the different cut depths enabled by the asymmetric arms.

FIG. 28 shows the embodiment of FIGS. 21-28 making the removing cut.

FIG. 29 is a schematic of the blade cutting and removing a portion of wood.

### DETAILED DESCRIPTION OF THE DRAWINGS

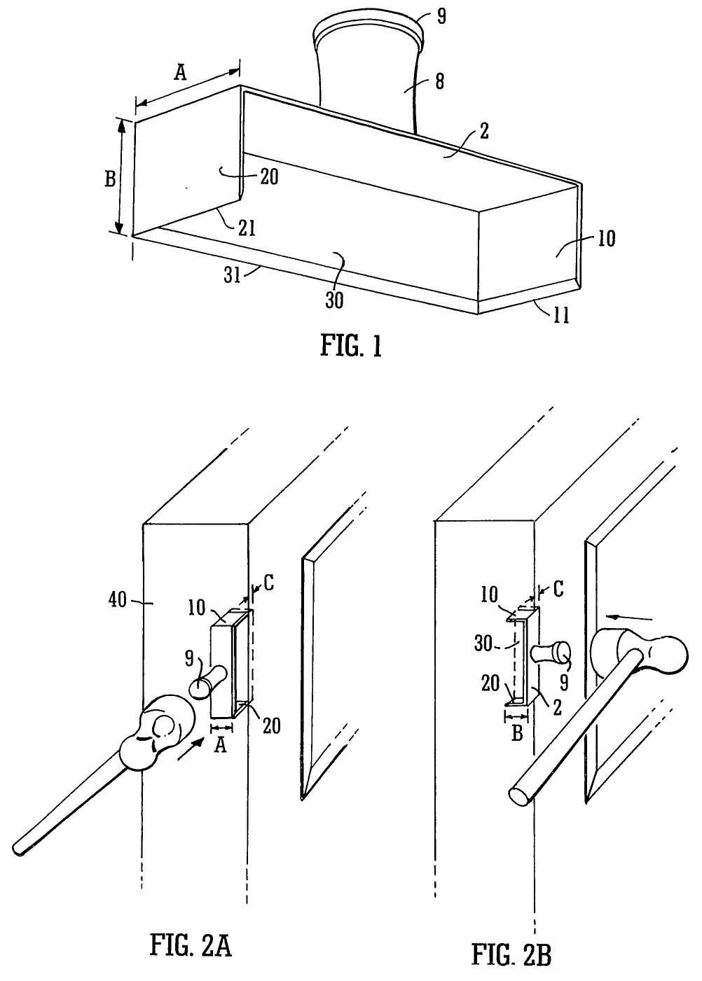

A first embodiment of a tool of the invention is now described with reference to FIGS. 1 to 2B of the drawings.

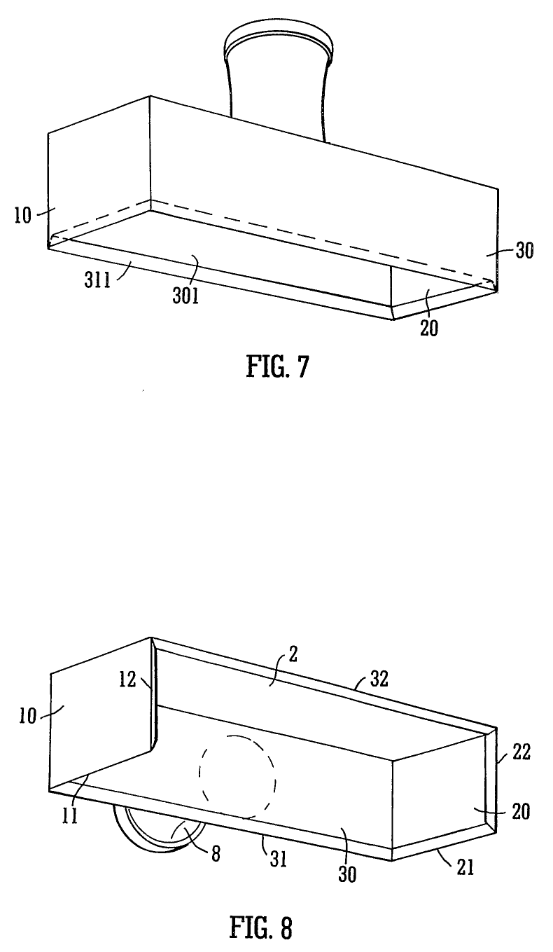

FIG. 1 shows a tool 1 generally in the form of a four-walled box, having a body portion in the form of a planar rectangular plate 2. First and second blades 10, 20 extend perpendicularly from the plate 2 at opposed transverse ends of the plate 2. A third blade 30 extends perpendicularly from one of the longitudinal sides of the plate 2, and is connected at each end to the first and second blades 10, 20, respectively. The first and second blades 10, are formed with bevelled cutting edges 11, 21. The length of the first and second cutting edges 11, 21 defines the maximum cut width A. A third cutting edge 31 (also bevelled) is disposed on the third blade 30. The first, second and third blades together define a substantially U-shaped inscribing blade suitable for scoring or inscribing a rectangular hinge outline on the edge of a door frame, as illustrated in FIG. 2A. It will be noted that the characterising portion of this embodiment, and the embodiment of FIG. 7 (described below) is that the maximum cut width A is substantially equal to the maximum depth of cut of the third blade 30.

A handle and combined strike bar 8 extends perpendicularly from the base 2 in the opposite direction away from the first, second and third blades 10, 20, 30. The handle 8 is provided with a flat top 9 to permit striking with a mallet or hammer, so that the tool can be employed as a punch.

In the embodiment shown in FIG. 1 the third blade can additionally be used as a removing blade, for removing the inscribed portion of wood, as described below. For that use the plate 2 acts as a stop (hereinafter referred to as a “removing stop” to control the depth of cut of the plate to a depth equal to the width A of the piece of wood to be removed to create the hinge recess. The distance B from the cutting edge 31 of the third blade 30 (the removing blade) to the body 2 is substantially equal to the maximum cut width A.

In use, the tool 1 is placed against the plane of a door or door jamb 40 as shown in FIG. 2a. Striking the flat top 9 with a mallet or hammer causes the first, second and third blades 10, 20, 30 to inscribe the wood to a cut depth C. In this embodiment the depth of cut of the inscribing blade (depth C) is controlled partly by the force applied to the bar 8, and partly by the depth of the bevelled cutting edges 11, 21, 31, which suitably have a depth equal to depth C. Thus, the blades 10, 20, 30 will be more disposed to penetrate the wood up to the limit of the bevelling; after this point, a greater force is required to drive the tool into the wood. The user will quickly become habituated to sensing when the blades 10, 20, 30 have penetrated up the limit of the bevel, and so sense the inscribing cut has been made. The maximum cut width A is determined by the length of the first and second cutting edges 11, 21.

The tool is then removed from the wood and placed against the side of the door or door jamb with the third blade 30 aligned at depth C (as shown in FIG. 2b). Striking the flat top 9 with a mallet or hammer causes the third blade 30 to move in a direction substantially perpendicular to the first cut to cleanly remove the required piece of wood in a single movement. As the distance from the edge of the third blade 30 to the plate 2 is substantially equal to the maximum cut width A, the tool penetrates the wood a distance B that is sufficient to completely remove the piece of wood without penetrating any further, and so does not damage the wood beyond the cuts made by the inscribing blade.

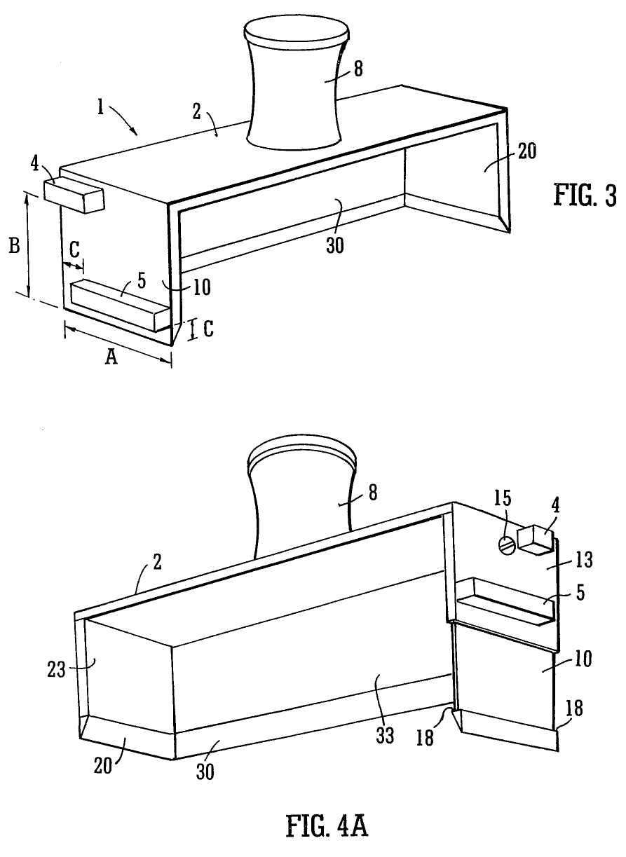

A second embodiment of a tool of the invention is shown in FIG. 3. A depth control stop (i.e. the removing stop) in the form of a first block 4 is attached to each of the first and second blade 10, 20. [In the embodiment shown in the drawing a first block 4 is located on the face of each of the blades 10, 20, but alternatively could be located on the inner face of each blade]. The first block 4 is located a distance B from the first cutting edge 11 of the first blade 10 such that distance B is substantially equal to the cut width A (another first block may be similarly placed on the second end wall 20). An inscribing depth control stop in the form of a second block 5 is also attached to outer face of each of the first and second blades 10, 20, and is located a cut depth C from the inscribing blade 30. In use, the second block 5 limits the cut-depth C that the inscribing blade can penetrate the wood. The second block 5 does not extend across the full width of the first or second blade 10, 20. The second block 5 is laterally spaced from the first block 4 a distance equal to or greater than the distance C from the third blade 30; this allows the removing blade to remove the recess material without being impeded by the inscribing stop 5 (second block 5). In some embodiments, the first block 4 may not be necessary as the body 2 may act as the removing stop.

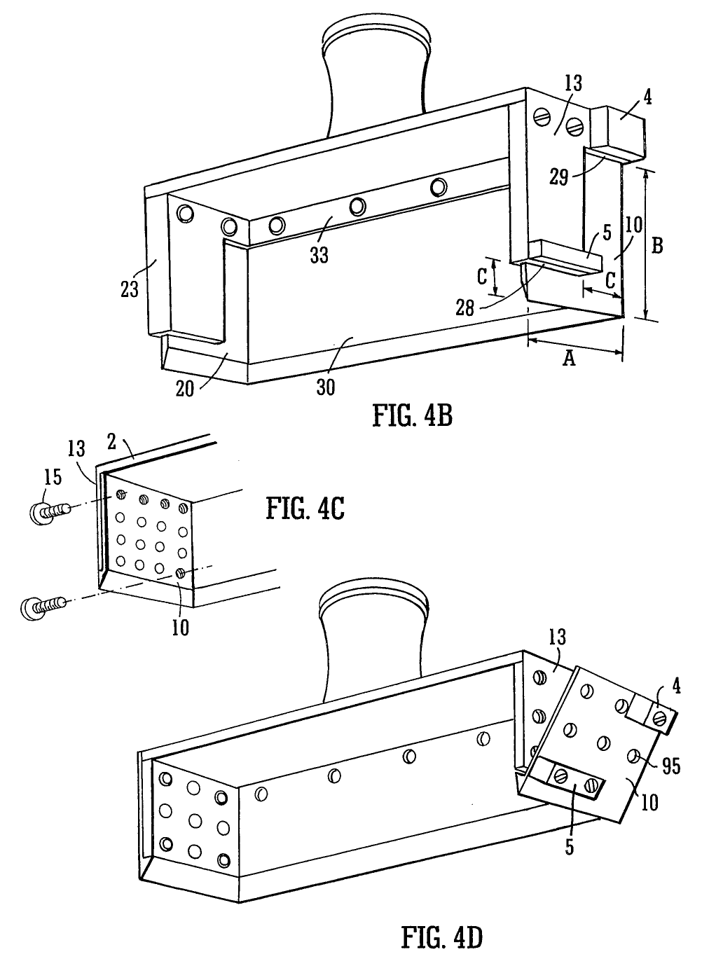

In alternative embodiments of the invention shown in FIGS. 4a-4d, the first, second and third blades 10, 20, 30 are removable and are mountable on first and second end-walls 13, 23 respectively and a side-wall 33. In the embodiment shown in FIG. 4a, the body of the blade 10 is housed within the end-wall 13. When the blade 10 is fully housed within the end-wall 13, the first cutting edge 11 protrudes from the end-wall 13. A similar arrangement of removable blades is disposed on the second end-wall 23 and the side-wall 33. The blade 10 is retained within the end-wall 13 by a blade-support retaining means in the form of a grub screw 15 (see FIG. 4c). In alternative arrangements, the blade support may be positioned at different distances from the body 2 and held in place by the grub screw 15. The removable blade 10 is provided with a lip 18 to abut flush against the end of the side-wall 13. The arrangement of the second and third blades 20, 30 are analogous. Different blades can be selected for different end use requirements.

The embodiment of FIG. 4b incorporates an alternative embodiment of the invention where the end-wall 13 has a recess whose width is at least substantially equal to the cut-depth C. This permits the first and second blade 10, 20 to pass through the inscribed cuts when the third blade 30 is acting as a removing blade (as in FIG. 2b). Although the distal end 28 of the end-wall 13 may act as an inscribing stop, it may be preferable to provide an additional extension in the form of a second block 5. A separate removing stop in the form of a first block 4 is located on each end-wall 13, 23; although the proximal end 29 of the end-wall 13 may act as a removing stop, it may be preferable to provide an additional extension as shown. FIGS. 4c and 4d show alternative versions of the removable blades 10, 20, 30 where these are adapted to be attached to the end-walls 13, 23 and side-wall 33, either on the inner face (4c) or the outer face (4d) of the side-walls and end-walls.

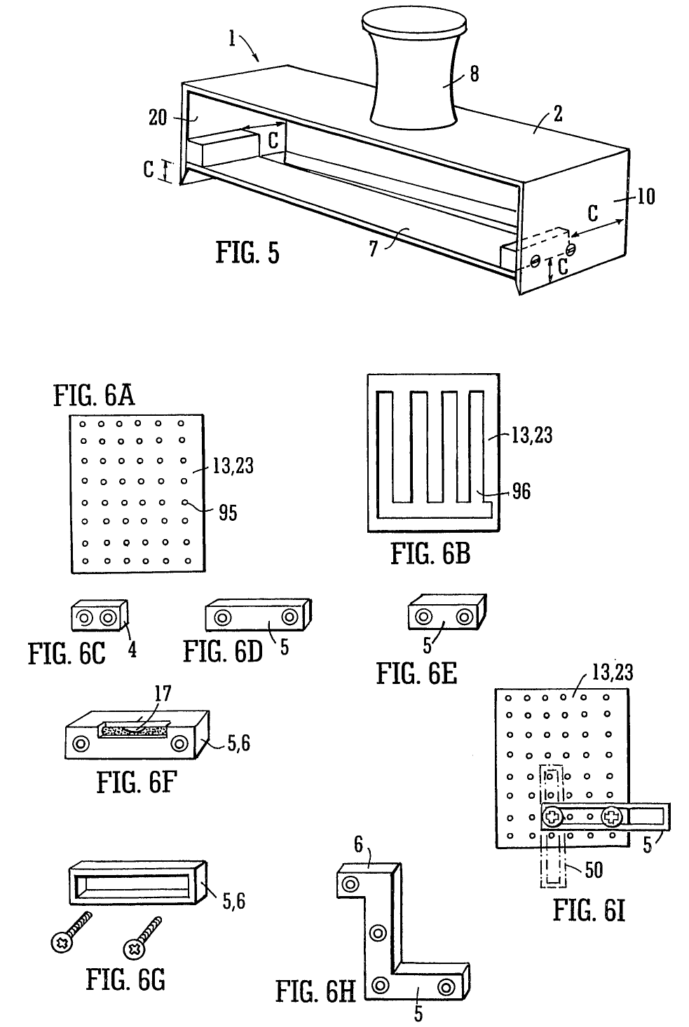

FIG. 5 shows a further embodiment of the invention where the inscribing stop extends between the first and second blades 10, 20 in the form of an internally extending strip 7. (the distance C is substantially equal on both sides: the representation of perspective in the figure makes it appear as though the distances are different).

FIGS. 6A-I show a variety of alternative inscribing stops, removing stops and end-walls. The end-wall 13, 23 may be provided with attachment means for the removable attachment of inscribing stops, removing stops and/or removable blades (blades). FIGS. 6A and 6B show different means of attachment; the provision of a series of screw holes 95 or slots 96 to enable the user select the location of the various articles of attachment. Favourably, the attachment may be by means of attaching one or both of a first block 4 or second block 5. Different versions of first blocks and second blocks are shown in FIGS. 6C-6H. FIG. 6G shows a second block 5 with an integrally formed spirit level 17. FIG. 6H shows an example of a first block 4 and second block 5 integrally formed. FIG. 6I shows an example of how a first block 4 may be moved between two positions; the first where it can act as an inscribing guide (ghost image) and the second, where it is rotated to act as a removing guide 50.

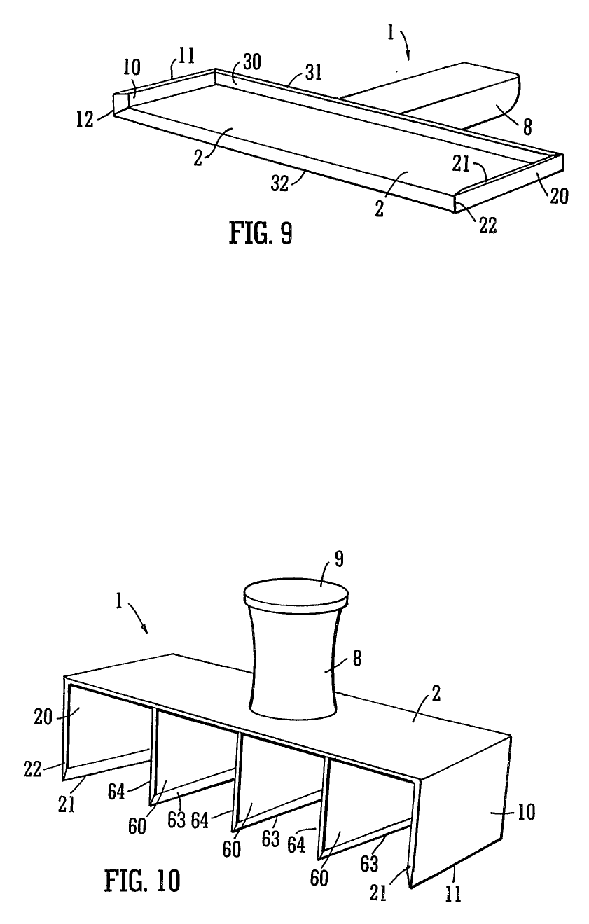

FIG. 7 shows an alternative embodiment comprising a seventh blade 301, extending between the first and second blades 10, 20 parallel to the third blade 30 (although there are 4 blades in the version of FIG. 7, the fourth blade 301 is described as the seventh blade to avoid confusion with the fourth, fifth and sixth blades 12, 22, 32 of the embodiment of FIGS. 8 and 9). The tool 1 of FIG. 7 generally has the shape of a rectangular box. A cutting edge 311 is located along the seventh blade 301 creating a substantially rectangular shaped inscribing blade.

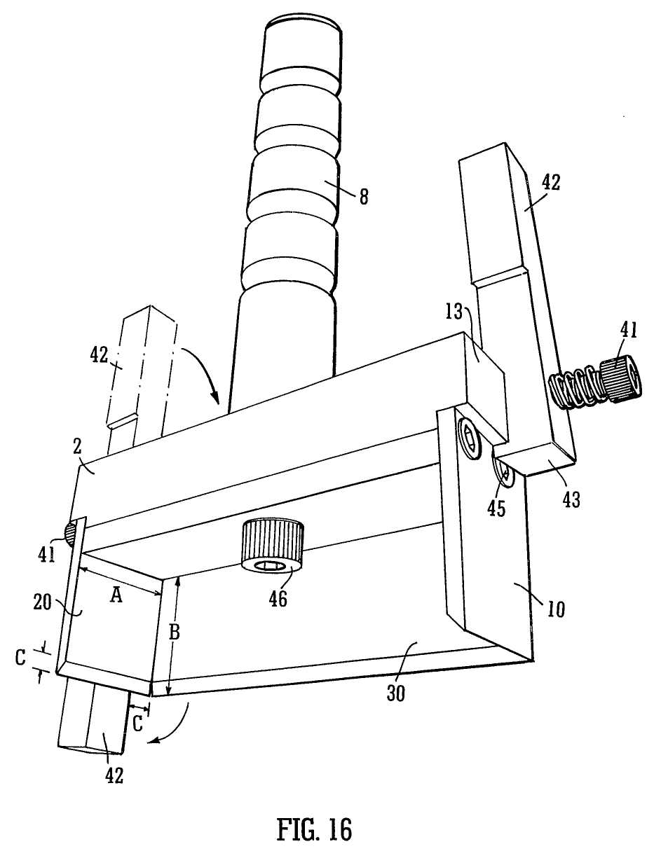

FIG. 16 shows another embodiment of the invention, where the body 2 is in the form of a block. The first and second blades 10, 20 are integrally formed with the body 2 and permit attachment of the first blade 10 and second blade 20 respectively by means of attachment screws 45. The third blade 30 is similarly independently formed from the body 2. Attachment of the third blade 30 to the body is also by means of screws (not shown). A handle 8 (and combined strike bar) extends from the body 2 and is attached to the body 2 by a handle-screw 46. The handle-screw 46 is positioned with at least a cut depth C clearance from the third blade 30 (although in alternative embodiments, the handle-screw 46 may act as a removing stop). Two arms (elongate blocks) 42 are pivotally mounted on the body 2 by means of a spring biased restraining screw 41. The spring biased restraining bolt 41 permits the arms 42 to rotate 180° so that when an arm 42 is in the position as shown over the first blade 10, the tool can be used to make the inscribing cut. The user pulls the restraining bolts 41 away from the body 2, so releasing the arms from their housing and permitting the restraining bolts to act as pivots so that the arms 42 can be pivoted between the various positions shown in FIG. 16. In the embodiment shown in FIG. 16, the thickness of the bevel of the blades allows the user to control the inscribing depth to a depth C with relative ease. However, in alternative embodiments, the short end 43 of the arms 42 may extend up to a cut-depth C from the cutting edge of the first blade so that the arm can also act as an inscribing stop when in the position shown over the first blade 10. Referring again to FIG. 16, after the inscribing cut has been made, the arms 42 may be pivoted about the restraining screw 41 so that the long end acts as a removing guide, as shown in the position of the arms over the second blade 20. The distance from the removing guide formed by the long end to the edge of the third blade is at least substantially equal to the cut depth C. The cut-width A may be substantially equal to the maximum length the removing blade can cut, A, as the body 2 acts as the restraining stop. In alternative embodiments, the cut-width may not be substantially equal to the removing-cut length and the inventions may be characterised by the arms 42, or the presence of a removing stop, or an inscribing stop or one or more of the various features described herein for any of the appropriate embodiments.

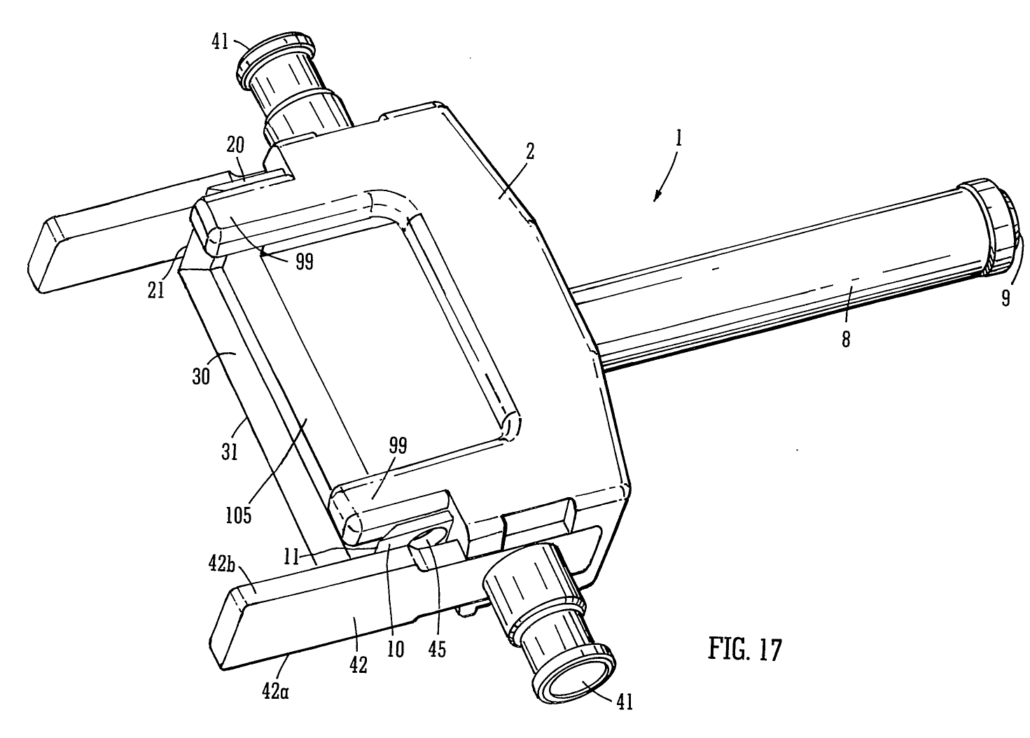

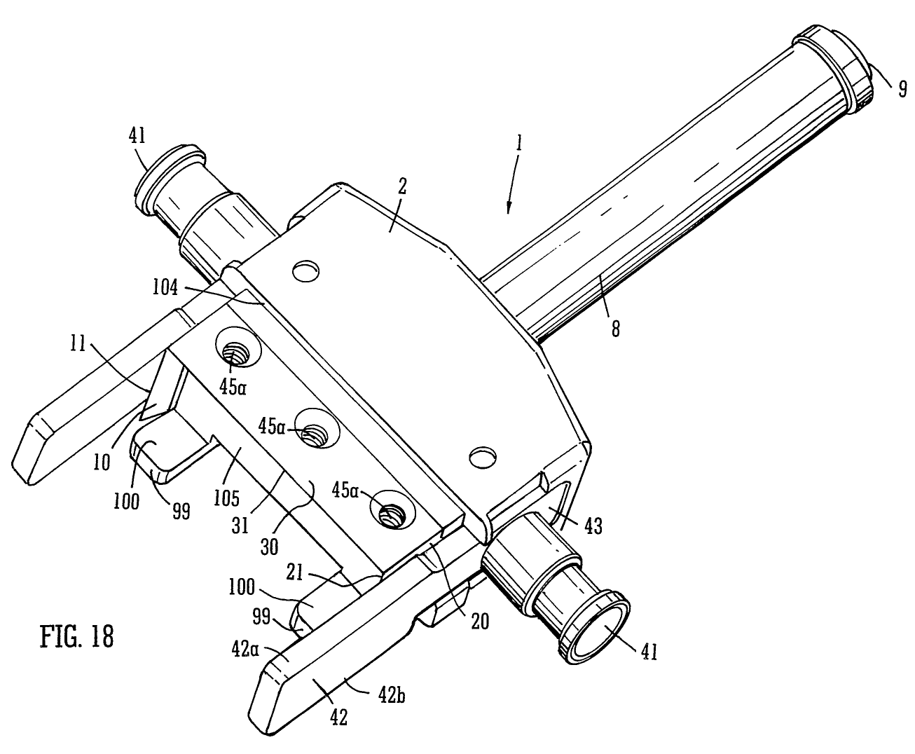

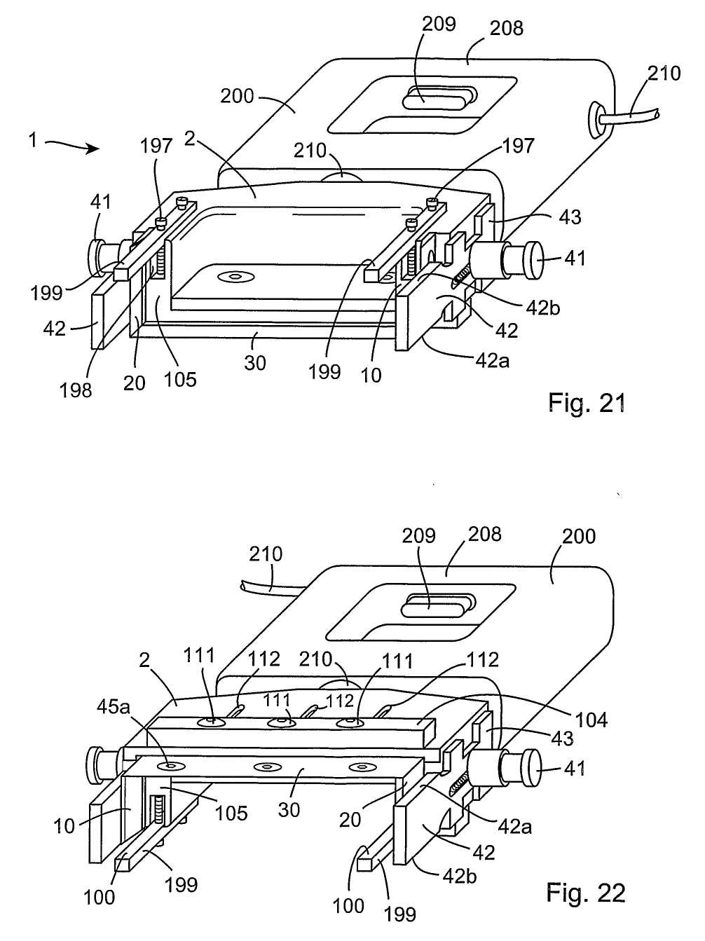

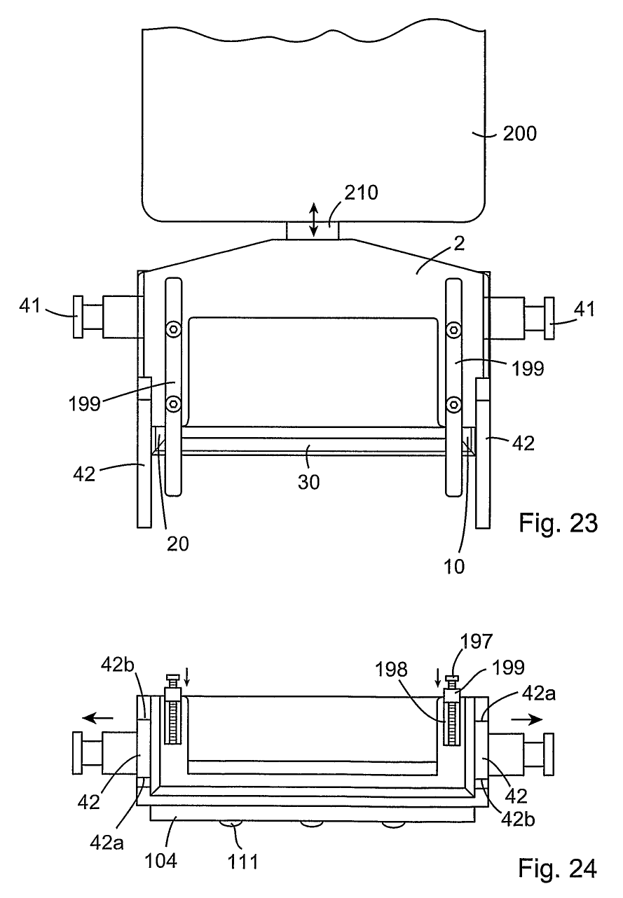

FIGS. 17 and 18 show a further embodiment, wherein the removing guide is located on the outside of the third blade 30, and is formed by a ledge 104, or extension of the body 2. The inscribing guide is formed by a block 105, located in the interior space defined by the first, second and third blades 10, 20, 30 and is integrally formed with the body 2. Thus, even though the interior space defined by the first, second and third blades of the embodiments of FIGS. 17-28 and similar embodiments do not permit the removed wood to be nestled within the space as can occur in some other embodiments, the third blade 30 can still penetrate the wood up until the removing guide in the form of the ledge 104 is reached. The embodiment of FIGS. 17 and 18 also shows two inscribing guides in the form of fingers 99. These can be removable (such as in FIGS. 21-28), although in the embodiment of FIGS. 17 and 18 they are integrally formed with the body 2. The removing guides comprise flat surfaces 100 facing the third blade 30 and separated from the third blade 30 by the maximum cut-width, (i.e. by the length of the first and second blades 10, 20). The flat surfaces 100 engage (rest against) with the edge of the wood when the surface of the wood is being inscribed.

In addition, the location of the arms 42 of the embodiment of FIGS. 17 and 18 can be reversed (by means of removing the restraining bolts 41), in that the arms 42 located on the left can be re-located on the right side of the tool and vice versa, so as to allow for a different inscribing depth when the arms 42 are being used as removing guides. It will be appreciated that while this embodiment is discussed specifically in relation to the embodiment of FIGS. 17 and 18, the same features are found in the embodiment of FIGS. 16 and 19-28, and indeed can be used in any suitable embodiment where the removing guides are removable. The guide portion 42a of the arms 42 is the portion that when in use, rests against the surface of the wood and so determined the maximum depth that the third blade can enter the edge of the wood at. This may be set at a particular level to complement the depth of the inscribing cut. In the embodiment shown in FIGS. 17 and 18, the guide portion 42 is asymmetrically flared and comprises a narrow guide portion 42a and a wide guide portion 42b. The narrow guide portion 42a allows a greater cut depth at which the third blade can penetrate the wood than if the narrow removing guide 42b was used. The narrow guide 42a and wide guide 42b of the removing guide (arms 42) each comprises a substantially flat edge set substantially parallel to the third blade 30 and further being offset from the third blade 30 by a distance substantially equal to a particular cut-depth (the depth of the inscribing cut) in a direction parallel to the first and second blades 10, 20 and towards the ends of the first and second blades 10, 20. Where the inscribing cut is a different length, (for example, where the inscribing cut is a lesser depth), the arms can be swapped, using the wide removing guide 42b instead of the narrow removing guide 42a where a greater cut depth was being made. Therefore both arms 42 are asymmetrical, in that each comprises a wide removing edge as defined above and a narrow removing edge, as described above, so as to provide for removing guides adapted for two different inscribing cut-depths.

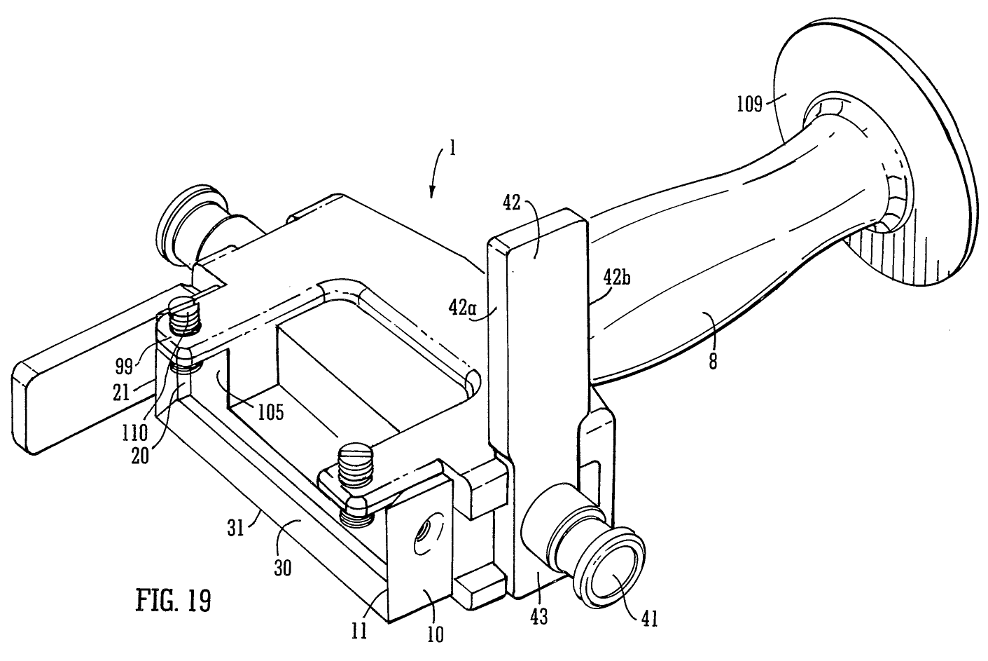

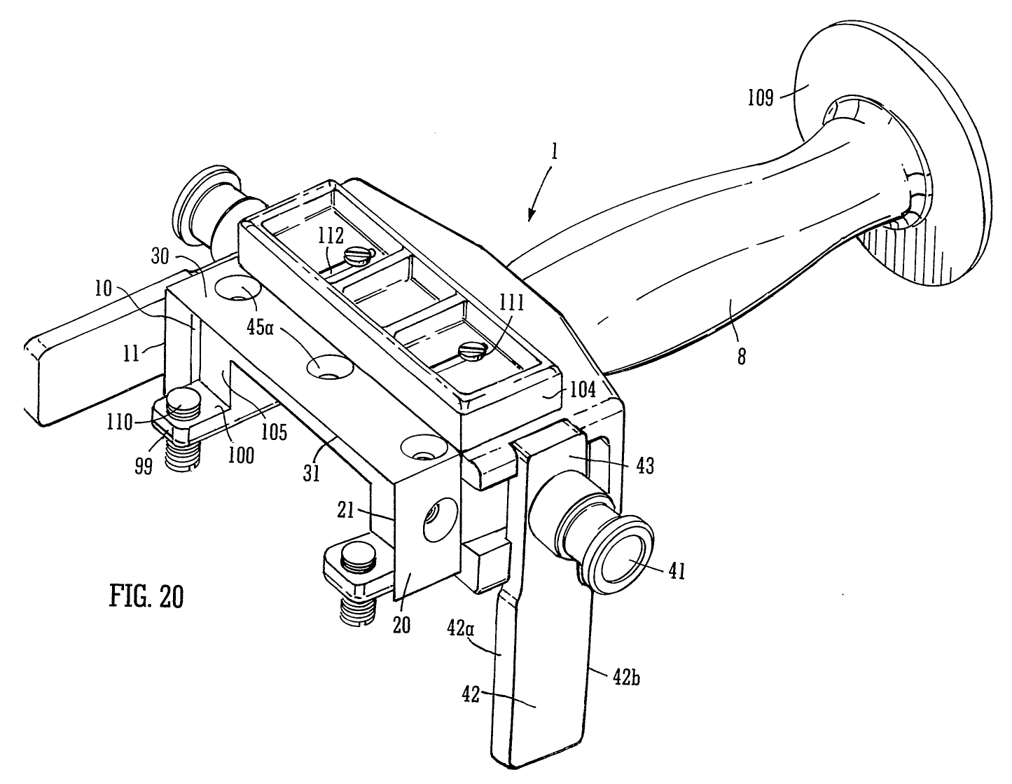

FIGS. 19-20 show another embodiment of the invention, similar to those of FIGS. 16-18. The handle 8 is provided with a hand guard 109 of rigid plastics material. Each inscribing guide is in the form of a finger 99 which is also provided with a screw 110 that can act as an extendable cut-width determining member, that is extendable from the inscribing guide so as to adjustably limit the effective cut-width. The screws may penetrate through the hole in the fingers 99 and may be accessible from either side of the fingers 99 (although only one version is depicted). In some embodiments, the fingers may not comprise a through threaded hole, but rather only a threaded partial hole accessible from the direction of the blades. The screws 110 may comprise gradations to help adjust the height accurately. The body 2 is also provided with a removing stop protection means in the form of a hard plastic cover 110 acting as a removing stop rather than the edged metal of the ledge 104 in FIGS. 17-18. This is held in place by means of holding screws 111 set into slots 112 in the hard plastic cover 110. In some embodiments, the position of the hard plastic cover 110 may be adjusted (and thus the position of the removing stop may be adjusted) by sliding the hard plastic cover 110 along the screws until the desired position is reached.

FIGS. 8, 9 and 10 are examples of 6-blade versions of the invention. In FIG. 8, fourth and fifth blades 12, 22 are formed by cutting edges placed perpendicular to the first and second cutting edges of the first and second blades 10, 20. A sixth blade 32 is formed by a cutting edge disposed along the planar body 2. The fourth, fifth and sixth blades thus form a substantially U-shaped blade. The third blade 30 acts as the removing stop. A further embodiment is shown in FIG. 9 where the tool 1 is generally in the form of a pan; the distance of the first, second and third blade 10, 20, 30 from the body 2 is substantially equal to the cut depth C. The removing blade is separate from the inscribing blade; thus the first, second and third blades 10, 20, 30 form the inscribing blade and the fourth, fifth and sixth blades 12, 22, 32 form the removing blade. In this embodiment, the body 2 acts as the inscribing stop and the third blade 30 acts as the removing stop.

FIG. 10 illustrates a further embodiment of the invention with a plurality of internal blades 60 set parallel to the first and second blades 10, 20. Each internal blade 60 ideally is provided with at least one cutting edge to act in concert with one or both of the inscribing blade and removing blade. In the embodiment shown, each of the internal blades 60 is provided with an internal inscribing blade 63 extending in the opposite direction from the body 2 and an internal removing blade 64 extending from the internal blade 60 in the opposite perpendicular direction from the third blade 30.

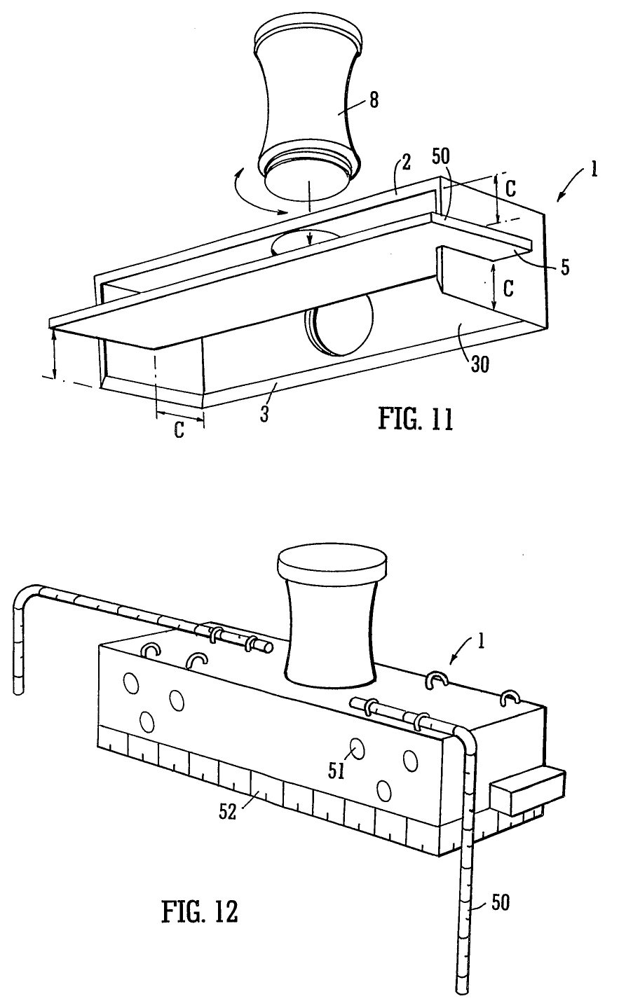

FIG. 11 show additional features of the invention which may be used with any suitable other features or embodiments, where the inscribing stop is integrally formed with a removing guide 50. In addition the handle 9 is detachable and reattachable by means of a screw thread such that when engaged in the recess or hole in the side-wall 30 or body 2, the threaded portion 7 of the handle strike bar 8 is flush with the side-wall 30 or body 2. FIG. 12 show further additional features of the invention which may be used with any suitable other features; the provision of guide holes 51 for drilling and gradations 52 for measurement located on the outside of the tool 1. The removing guide 50 may also function as an extendable guide to ensure the tool 1 is placed the correct distance from the end of the door.

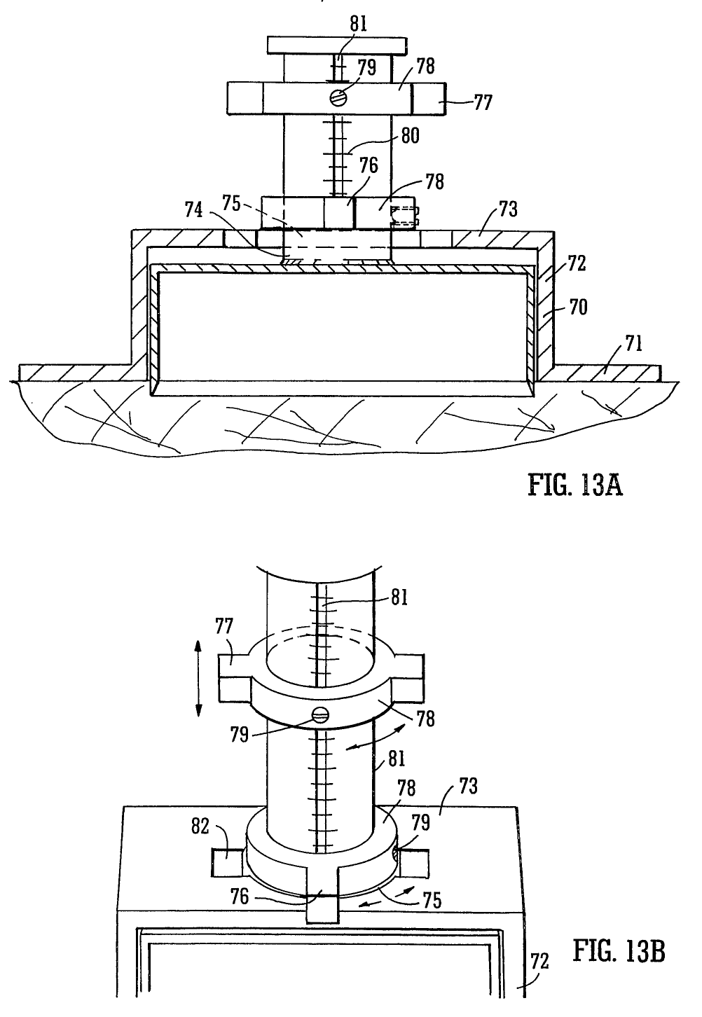

A further embodiment of the invention is shown in FIGS. 13a and 13b. The tool is located within a support means in the form of a housing 70. The support means acts to abut the tool against a surface and permit the blades to extend into the surface while the support abuts the surface. The support or housing may be substantially wall-like, or may be a skeleton or scaffold. The housing 70 is provided with a flat base 71, support walls 72 and a roof 73. The tool is mounted in the housing 70 by means of a spring biased compression shaft 74 extending through an aperture 75 in the roof 73. The compression shaft is provided with a first extension stop 76 and a second extension stop 77 located on a pair of cylindrical collars 78 surrounding the compression shaft 74. The compression shaft 74 is provided with cut distance-gradations 80. The cylindrical collars 78 are provided with adjustment screws 79 for fixing their position along grooves 81 in the compression shaft 74. The aperture 75 is provided with discriminating (selection) means 82 to selectively prevent the first extension stop 76 extend through the aperture 75 in one position; but permit the passage of the first extension stop 76 in a second position. In this way once the inscribing cut has been made the user can rotate the compression shaft 74 to permit the first extension stop 76 extend through the aperture 75 and so permit full extension of the removing blade by the required cut width distance as determined by the position of the second collar on the gradations of the compression shaft. Thus, the first extension stop 76 acts as an inscribing stop and the second extension stop 77 acts as a removing stop.

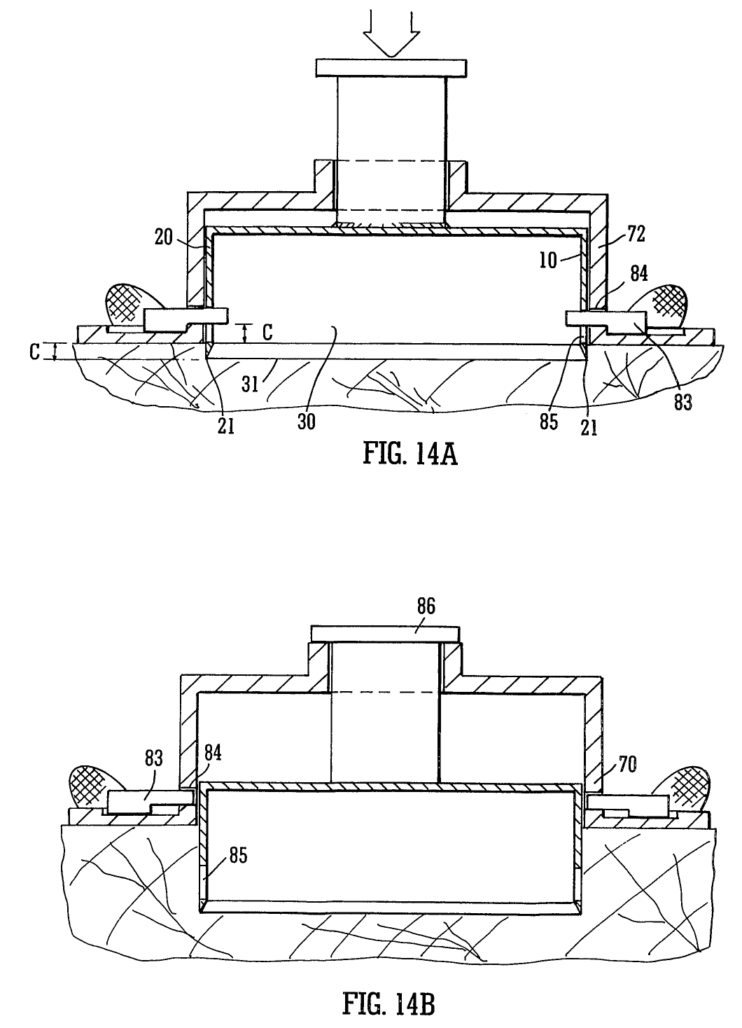

An alternative arrangement is shown in FIGS. 14a and 14b. The support walls 72 are provided with catches 83 that may be slidably passed through apertures in the support wall 84 to reversibly engage with the side-walls 10, 20 by means of passing through side-wall apertures 85. The length of the side-wall aperture 85 measured along the inscribing blade axis is substantially equal to the cut depth C plus the thickness of the catch 83. Thus, when the catches 83 are engaged with the side-wall apertures 85 the inscribing blade 3 can only extend from the housing 70 by the cut depth C. Thus, the side-wall apertures 85 act as inscribing stops.

When the catches 83 are disengaged from the side-wall apertures 85, the tool 1 can extend from the housing 70 by the full length of the removing blade, and is prevented from further extension by a plunger removing stop 86 located at the flared top 87 of the plunger shaft 88 extending from the tool 1 through the roof 73.

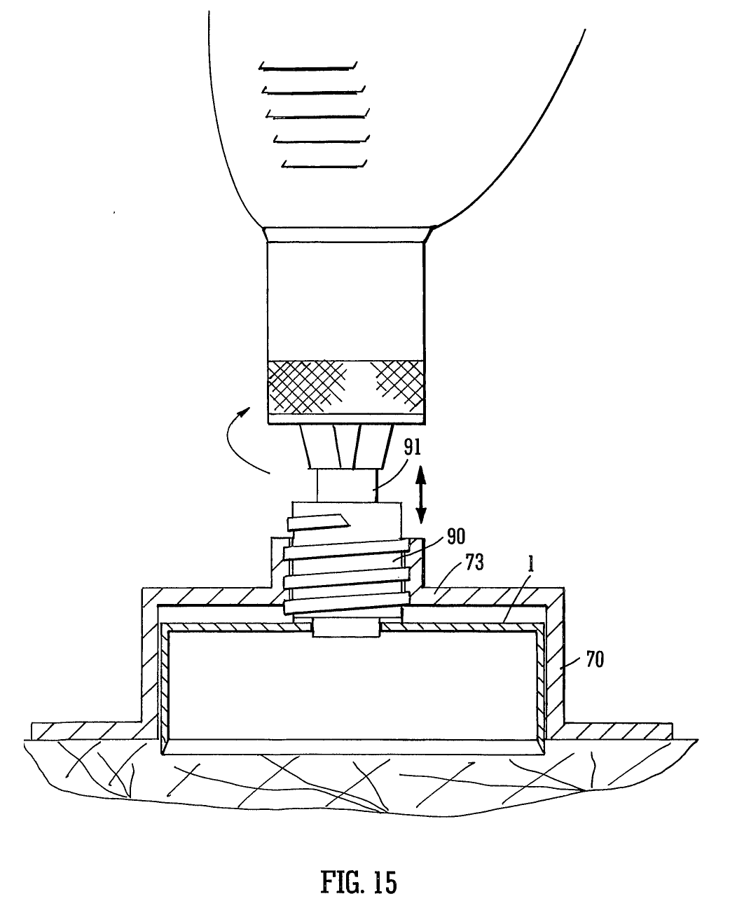

FIG. 15 shows a further embodiment, which is powered, in this case, (for activation) by a drill bit. A threaded compression shaft 90 extends from the tool 1 through the roof 73 of the housing 70. A drill bit 91 engages with the threaded compression shaft 90 to extend the tool 1. Naturally, means to control the cut depth are provided, such as those herein described.

FIGS. 21-28 show a further embodiment of the tool, wherein the tool further comprises a hand-held power unit 200 capable of delivering the force required to drive the blades into the wood and powered via a mains cable 210. The tool comprises a body, 2, connected to a hand-held power unit 200 by means of a reciprocating ram 210. The reciprocating ram 210 is fixedly attached to the body 2 and is movably extendable from the power unit 200. In use, activation of the power unit 200 by means of pressing the trigger 209, located on the power unit handle 208, causes the ram 210 to move in and out of the power unit 200 with force and at high speed. This provides a jackhammer-like action to the tool that can be used to make the necessary cuts in the wood. The provision of arms 42 and fingers 99 allows the tool to be positioned correctly and avoids the risk of the excess incisions in the wood.

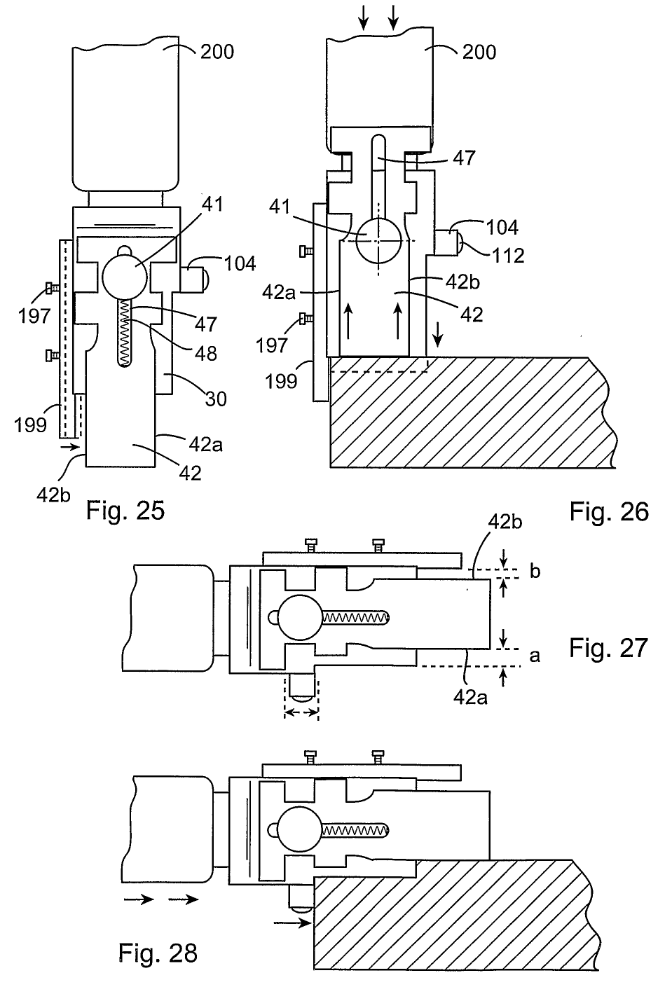

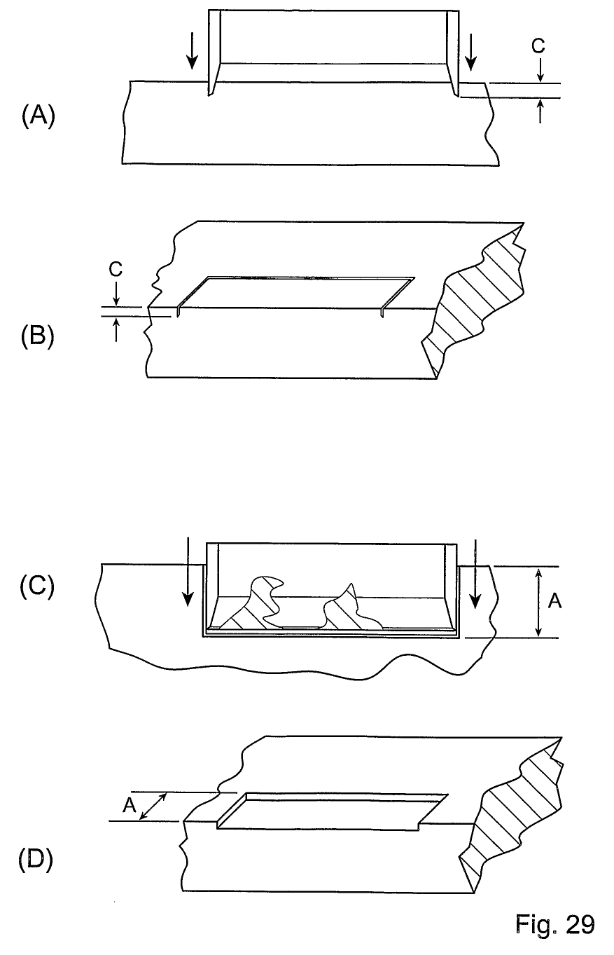

As shown in FIGS. 21-28, the arms 42 may be slidably mounted in a slot 47. The slot 47 may comprise a spring 48 biased to return the arms to the position shown in FIG. 25. In use, when the inscribing cut is to be made, the user places the ends of the arms 42 against the surface of the wood and pushes the tool closer to the surface of the wood, causing the arms 42 to slide up along the slot, thereby compressing the spring 48 and so bringing the blades 10, 20, 30 in contact with the surface of the wood. Activation of the power-unit then drives the tool into the wood as far as block 105 permits. By slidably mounting the arms 42, therefore, the user does not need to rotate the arms 42 between making the inscribing and removing cuts. Naturally, the feature of slidably mounted arms may be used in any of the embodiments that comprise arms 42, and in particular, such embodiments as those exemplified by FIGS. 16-20.

The tool may also comprise inscribing guides in the form of adjustable fingers 199. The position of the adjustable fingers 199 may be adjustable such that the inscribing guide also acts as a cut-width determining member. Screws 197 are provided within an inscribing guide slot 198 so as to permit the position of the inscribing guides to be adjusted. Naturally, the feature of adjustable inscribing guides and/or combined inscribing guides and cut-width determining members may be used in any of the embodiments herein described, and may also be used in conjunction with separate cut-width determining members such as those described in conjunction with FIGS. 19 and 20 (e.g., screws 110).

As described in conjunction with other figures, the arms 42 may be interchangeable and may be provided with narrow guide portions 42a and wide guide portions 42b so as to allow for two different cut depths. The position of the removing stop 104 may be adjustable, for example, by mean of slots 112 and screws 111.

The words “comprises/comprising” and the words “having/including” when used herein with reference to the present invention are used to specify the presence of stated features, integers, steps or components but does not preclude the presence or addition of one or more other features, integers, steps, components or groups thereof.

It is appreciated that certain features of the invention, which are, for clarity, described in the context of separate embodiments, may also be provided in combination in a single embodiment. Conversely, various features of the invention which are, for brevity, described in the context of a single embodiment, may also be provided separately or in any suitable sub-combination.

From the foregoing, it will be apparent that numerous modifications and variations can be effected without departing from the true spirit and scope of the novel concept of the present invention. It will be appreciated that the present disclosure is intended to set forth the exemplifications of the invention which are not intended to limit the invention to the specific embodiments illustrated. The disclosure is intended to cover by the appended claims all such modifications as fall within the scope of the claims.

Where technical features mentioned in any claim are followed by reference signs, these reference signs have been included for the sole purpose of increasing the intelligibility of the claims and accordingly, such reference signs do not have any limiting effect on the scope of each element identified by way of example by such reference signs.

1-48. (canceled)

49. A tool suitable for inscribing and removing a portion of a wooden member, comprising:
a support member,
first and second blades extending substantially perpendicularly from the support member in spaced apart parallel relationship,
a third blade extending between opposite lateral ends of the first and second blades (10, 20),
cutting edges on the blades which between them define the outline of the portion of wood to be inscribed and removed,
a first control means to control the depth of cut of the third blade when the tool is used to cut away the inscribed portion,
and further comprising a removing guide for guiding the tool during removal of the inscribed portion, the removing guide comprising two pivotal arms each on opposing sides of the tool.

50. A tool according to claim 49 further comprising a second control means to control the depth of cuts of the blades when the tool is used to inscribe the portion to be cut.

51. A tool as claimed in claim 50, wherein the second control means is an inscribing stop.

52. A tool as claimed in claim 50, wherein the position of the second control means is adjustable.

53. A tool as claimed in claim 49, further comprising an attachment means for a drill or rivet gun.

54. A tool as claimed in claim 49, wherein the attachment means for a drill or rivet gun is a drill bit engagable with the support member.

55. A tool as claimed in claim 49, further comprising a handle.

56. A tool according to claim 49 further comprising one or more additional blades extending substantially perpendicularly from the support member and being in spaced apart substantially parallel relationship to the first and second blades.

57. A tool according to claim 49 further comprising one or more inscribing guides, extending past the cutting edges of the first, second and third blades, such that when the first, second and third blades are resting on a substantially flat surface, with the ends of the first and second blades at the edge of the surface, the inscribing guide rests against an edge of the surface substantially perpendicular to the surface so as to align the ends of first and second blades with the edge of the surface.

58. A tool according to claim 49 wherein the blades are independently formed from the support member.

59. A tool as claimed in claim 49, comprising a cut-width determining member arranged to adjustably limit the portion of the maximum cut-width that the first and second cutting blades (10, 20) use in making a cut; the portion defining an effective cut-width.

60. A tool as claimed in claim 49, wherein the cut-width determining member is positionable so as to limit the longest length the cutting edges of the first and second blades that can rest against a substantially flat surface when the tool is placed against the edge of a substantially flat surface.

61. A tool according to claim 49 wherein the tool is moveably mounted within an external housing such that the blades can extend from housing.

62. A tool as claimed in claim 61 wherein the support member of the tool is attached to one or more compression shafts extending through the housing.

63. A tool as claimed in claim 62, wherein the compression shafts are spring mounted.

64. A tool suitable for inscribing and cutting out a hinge recess from a door frame, the tool comprising
a support member,
first and second blades extending substantially perpendicularly from the support member in spaced apart substantially parallel relationship,
a third blade extending between opposite lateral ends of the first and second blades,
wherein the tool further comprises a hand-held power unit, attachable to the support member by means of a driver, the driver being movably engagable with the hand-held power unit such that the blades may be reciprocally powered by the hand-held power unit.

65. A tool as claimed in claim 64, comprising a first control means to control the depth of cut of the third blade (30) when the tool is used to cut away the inscribed portion.

66. A tool as claimed in claim 65, wherein the first control means is positionable such that the distance the third blade can penetrate through a piece of wood along the longitudinal axis of the third blade may be limited by the first control means, said distance defining a removing-cut length.

67. A tool as claimed in claim 66, wherein the removing cut-length may be adjustable by means of adjustably moving the position of the first control means relative to the cutting edge of the third blade.

68. A tool as claimed in claim 64, comprising a removing guide with a guide portion extendable away from the support member and past the cutting edge of the third blade, the guide portion being substantially parallel to the longitudinal axis of the third blade and further being offset from the longitudinal axis of the third blade.

69. A tool as claimed in claim 64, further comprising one or more inscribing guides, extending past the cutting edges of the first, second and third blades, such that when the first, second and third blades are resting on a substantially flat surface, with the ends of the first and second blades at the edge of the surface, the inscribing guide rests against an edge of the surface substantially perpendicular to the surface so as to align the ends of first and second blades with the edge of the surface.

70. A tool according to claim 65, wherein the position of the first control means is adjustable.

71. A tool according to claim 65, wherein the first control means is a removing stop.

72. A tool as claimed in claim 71 wherein the first control means extends in a direction away from the space outlined by the blades.

73. A tool according to claim 64 wherein the tool further comprises a powered means which is arranged to extend the blades away from the support member.

74. A tool as claimed in claim 73 wherein the extension of one or more of the blades from the tool may be effected by engagement by the tool or housing with a drill bit.

75. A tool according to claim 64 wherein the tool is moveably mounted within an external housing such that the blades can extend from housing.
